(19) United States
(12) Patent Application Publication
(10) Pub. No.: US 2018/0012194 A1
(43) Pub. Date: Jan. 11, 2018

(54) INFORMATION PROCESSING SYSTEM, INFORMATION PROCESSING DEVICE, INFORMATION PROCESSING METHOD, AND RECORDING MEDIUM

(71) Applicants: Junki AOKI, Kanagawa (JP); Hiroaki IKKANZAKA, Saitama (JP)

(72) Inventors: Junki AOKI, Kanagawa (JP); Hiroaki IKKANZAKA, Saitama (JP)

(73) Assignee: Ricoh Company, Ltd., Tokyo (JP)

(21) Appl. No.: 15/633,967

(22) Filed: Jun. 27, 2017

(30) Foreign Application Priority Data
Jul. 11, 2016 (JP) 2016-136664
Apr. 28, 2017 (JP) 2017-090208

(51) Int. Cl. G06Q 10/10; H04L 29/06

(52) U.S. Cl. CPC G06Q 10/1095; H04L 65/403

(57) ABSTRACT

An information processing system includes circuitry to: generate meeting information indicating contents of a meeting, based on data used by the meeting, the data being stored in at least one information terminal connected through a network; extract partial information from the meeting information to generate the partial information having an output format, based on a request received from the at least one information terminal through the network during the meeting; and output the partial information to at least one of the at least one information terminal and an output device connected through the network, to cause the meeting information and the partial information to be transmitted to the at least one information terminal through the network.

### CROSS-REFERENCE TO RELATED APPLICATIONS

This patent application is based on and claims priority pursuant to 35 U.S.C. §119(a) to Japanese Patent Application Nos. 2016-136664, filed on Jul. 11, 2016, and 2017-090208, filed on Apr. 28, 2017, in the Japan Patent Office, the entire disclosure of which is hereby incorporated by reference herein.

### BACKGROUND

### Technical Field

The present invention relates to an information processing system, an information processing device, an information processing method, and a recording medium.

### Description of the Related Art

For example, there is a technique of managing time during which an output electronic device under a network environment outputs presentation materials to be presented, arranging the presentation materials and meeting materials in accordance with time information, and creating minutes data.

### SUMMARY

Example embodiments of the present invention include an information processing system including circuitry to: generate meeting information indicating contents of a meeting, based on data used by the meeting, the data being stored in at least one information terminal connected through a network; extract partial information from the meeting information to generate the partial information having an output format, based on a request received from the at least one information terminal through the network during the meeting; and output the partial information to at least one of the at least one information terminal and an output device connected through the network, to cause the meeting information and the partial information to be transmitted to the at least one information terminal through the network.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view of an exemplary configuration of an information processing system according to a first embodiment;

FIG. 2 is a diagram illustrating an exemplary hardware block of a server according to the first embodiment;

FIG. 3 is a diagram illustrating an exemplary hardware block of a PC according to the first embodiment;

FIG. 4 is a diagram illustrating an exemplary functional block of the server according to the first embodiment;

FIG. 5 is a diagram illustrating an exemplary functional block of an information terminal according to the first embodiment;

FIG. 6 is a diagram illustrating an exemplary data storage structure of minutes data, snapshot data, and AI information, managed in the server, according to the first embodiment;

FIG. 7 is a diagram illustrating an exemplary user interface displayed on the information terminal by a snapshot generation requestor, according to the first embodiment;

FIG. 8 is a diagram illustrating an exemplary user interface displayed in a case where information for a snapshot has been selected in the user interface in FIG. 7, according to the first embodiment;

FIG. 9 is a diagram illustrating an exemplary user interface displayed following the user interface illustrated in FIG. 8, according to the first embodiment;

FIG. 10 is a flowchart of exemplary processing performed by the server that has received a command for creating the snapshot, from the information terminal, according to the first embodiment;

FIG. 11 is a table of exemplary index data for searching the snapshot and the AI information, according to the first embodiment;

FIG. 12 is a sequence diagram illustrating exemplary processing of creating the snapshot, according to the first embodiment;

FIG. 13 is a sequence diagram illustrating exemplary processing for a user to browse the snapshot, according to the first embodiment;

FIG. 14 is a diagram illustrating an exemplary user interface for the user to browse the snapshot, according to the first embodiment;

FIG. 15 is a flowchart of exemplary processing performed by the server in sending the AI information to the information terminal, according to the first embodiment;

FIG. 16 is a sequence diagram illustrating exemplary processing from registration of the AI information to storage of the AI information into the information terminal, according to the first embodiment;

FIG. 17 is a diagram illustrating an exemplary user interface in browsing AI data through the information terminal, according to the first embodiment;

FIG. 18 is a flowchart of exemplary processing performed by the server in sharing the AI information at a number of places during an electronic meeting, according to the first embodiment;

FIG. 19 is a sequence diagram illustrating exemplary processing in starting the electronic meeting in the information processing system according to the first embodiment;

FIG. 20 is a diagram illustrating an exemplary user interface for creating the AI information or the snapshot during the progress of the electronic meeting, according to the first embodiment;

FIG. 21 is a diagram illustrating an exemplary functional block of a server according to a second embodiment;

FIG. 22 is a flowchart of exemplary processing performed by the server that has received a command for creating a snapshot, from an information terminal, according to the second embodiment;

FIG. 23 is a diagram illustrating an exemplary user interface for creating the snapshot during the progress of an electronic meeting, according to the second embodiment;

FIG. 24 is a diagram illustrating an exemplary user interface for displaying a slide show of the snapshot when the electronic meeting finishes, according to the second embodiment; and

FIG. 25 is a diagram illustrating exemplary data storage structures of minutes data and snapshot data, managed in the server, according to the second embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A conventional technique of creating minutes data only arranges materials on a time-series based on the created date and time of meeting materials. Thus, there is a disadvantage that the point of a meeting is difficult to review collectively after the meeting.

In view of the above, it is desirable to extract the point of meeting materials created under a network environment and to effectively create data for referring to the contents of a meeting after the meeting.

### First Embodiment

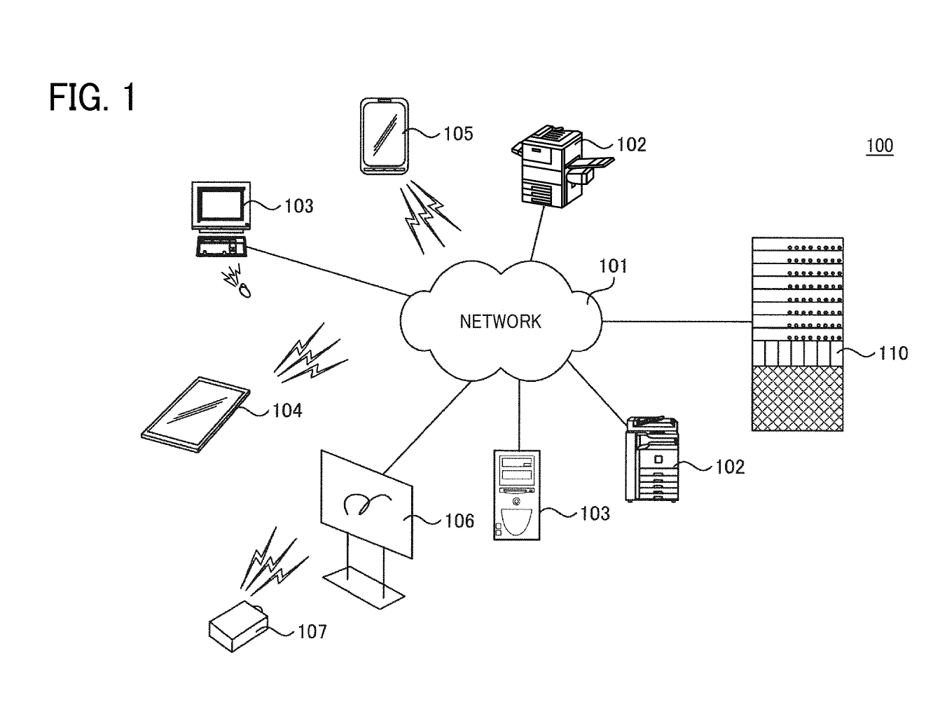

The present invention will be described below with embodiments, but is not limited to the embodiments to be described. FIG. 1 is a schematic view of an information processing system 100 according to a first embodiment. The information processing system 100 illustrated in FIG. 1 is implemented as an electronic meeting system in a specific embodiment, and includes a plurality of information processing devices connected to a network 101. The network 101 can include at least one of the Internet and a local area network (LAN). Note that, an electronic meeting according to the present embodiment is referred to as a meeting with data stored in at least one information terminal connected through a network.

The information processing system 100 includes information terminals, such as an image processing device 102, a smartphone 105, a personal computer 103 (hereinafter, referred to as a PC 103), and a tablet PC 104, and a server 110 as an exemplary information processing device, connected through the network 101. The Information terminals and the information processing device connected to the network 101, are not limited to the above, and are not particularly limited if being any devices capable of performing information and communication through the network 101.

For example, the PC 103 varies a performable function in response to the attribute of a user operating the PC 103. For example, the start and finish of an electronic meeting can be controlled in a case where the user is an administrator. The user not being the administrator is allowed to participate in the electronic meeting from the PC 103, to upload a document or an image to the server 110 that controls the electronic meeting. Note that, the smartphone 105 and the tablet PC 104 can also access the server 110, similarly to the PC 103. The image processing device 102 includes a multi-functional printer (MFP).

According to the present embodiment, the system 100 further includes a whiteboard 106 connected to the network 101. A participant in the electronic meeting makes drawing on the whiteboard 106 to give various presentations. The server 110 combines the presentations made at different places, for projection on the whiteboard 106 using a projector 107. With a display of combined presentations made at a plurality of spots, the meeting can be facilitated. A display device mounted on each information terminal, the whiteboard 106, or a projected screen, corresponds to an output device according to the present embodiment.

According to the present embodiment, the server 110 combines information acquired from a number of remotely-located places, and stores the combined information as minutes data, for users who participate in the electronic meeting from a number of the places. Electronic meeting information according to the present embodiment corresponds to the minutes data generated in this manner, and will be specifically referred to as the minutes data below. The server 110 according to the present embodiment allows each user to acquire files or any other information for later use while viewing the electronic meeting, without interrupting the progress of the electronic meeting. That is, the server 110 is able to control processing on the file or any other information for reference by the user, while controlling output of information at the meeting. The user is then able to browse information in asynchronization with the progress of electronic meeting. In this disclosure, the files or any other information that the user acquires for later use are referred to as partial information of the electronic meeting information, and are specifically referred to as a snapshot and information for requesting an action to be taken. Further, such partial information may be referred to by the user during the meeting, in asynchronization with the progress of meeting.

The server 110 can provide a plurality of functions, as it is called, such as a Web server, a storage server, a mail server, and an authentication server. The exemplary configuration illustrated in FIG. 1, illustrates the server 110 as a rack-mountable server including a plurality of appliance servers. In addition, with a different exemplary configuration, a plurality of stand-alone servers cooperates with each other so that a service function for the electronic meeting can be provided.

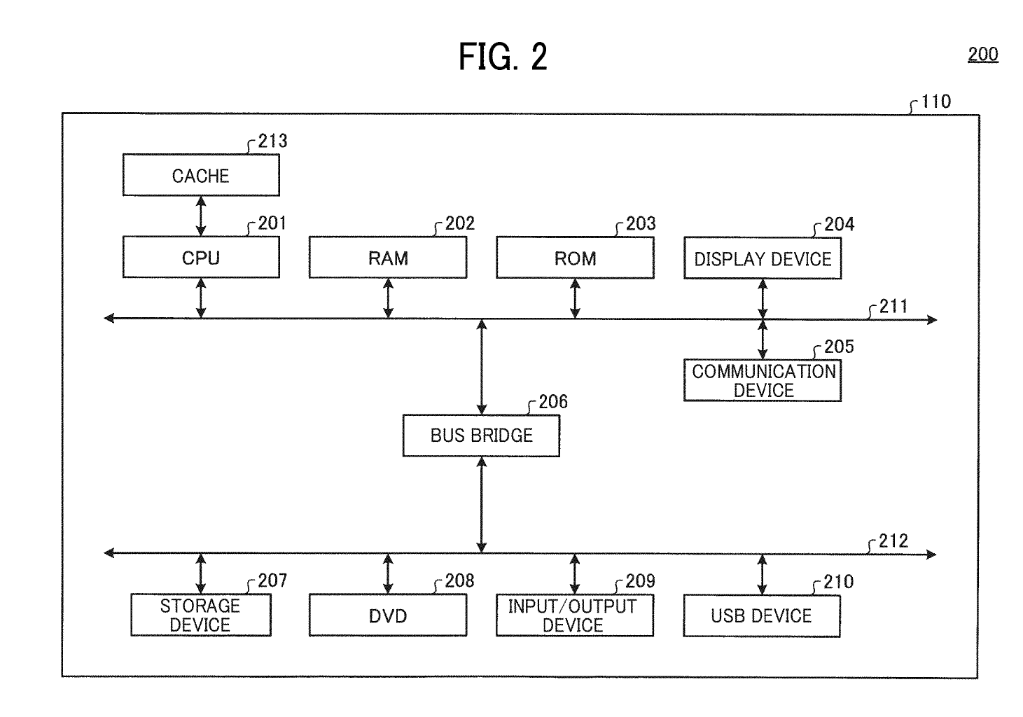

FIG. 2 illustrates a hardware block 200 of the server 110 according to the first embodiment. The server 110 can be implemented as a server dedicated machine, such as a workstation or an appliance server, or a general-purpose computer. The server 110 includes a central processing unit (CPU) 201, a cache memory 213, a random-access memory (RAM) 202, a read-only memory (ROM) 203, and a display device 204, connected through a system bus 211.

The display device 204 provides a function of managing the states of an OS and an application in the server 110, and displays video information on a liquid crystal display with an appropriate protocol, such as video graphics array (VGA), digital visual interface (DVI), or high-definition multimedia interface (HDMI) (registered trademark). A communication device 205 includes a network interface card (NIC), and uses a protocol for Ethernet (registered trademark) or optical communication, such as fiber to the home (FTTH), to allow a data transfer with a communication protocol, such as hypertext transfer protocol (HTTP), file transfer protocol (FTP), post office protocol (POP), or simple mail transfer protocol (SMTP), through a LAN or Ethernet (registered trademark).

The system bus 211 is connected to an I/O bus 212 through a bus bridge 206, such as peripheral component interconnect (PCI) or PCI Express. The I/O bus 212 is connected to a storage device 207 such as a hard disk drive (HDD), an optical recording device 208 such as a digital versatile disc (DVD), and an input/output device 209 such as a keyboard or a mouse, using an appropriate protocol, to allow input and output with respect to the server 110. The I/O bus 212 is further connected to a USB-bus connectable universal serial bus (USB) device 210, using electrically erasable programmable read-only memory (EEPROM) (registered trademark) or erasable programmable read-only memory (EPROM) (registered trademark).

Examples of the CPU 201 in the server 110 include, but are not limited to, XEON (registered trademark), a PENTIUM (registered trademark) compatible CPU, and POWER PC (registered trademark) in addition to PENTIUM (registered trademark) to PENTIUM IV (registered trademark), ATOM (registered trademark), CORE 2 DUO (registered trademark), CORE 2 QUAD (registered trademark), and COREi (registered trademark) in series.

Examples of the operating system (OS) include Windows Server (registered trademark), UNIX (registered trademark), LINUX (registered trademark), OPENBSD, and any other appropriate OS. Furthermore, the server 110 is able to store and execute an application program described in a program language, such as an assembler language, C, C++, Visual C++, Visual Basic, Java (registered trademark), JavaScript (registered trademark), Perl, or Ruby, to run on the OS described above.

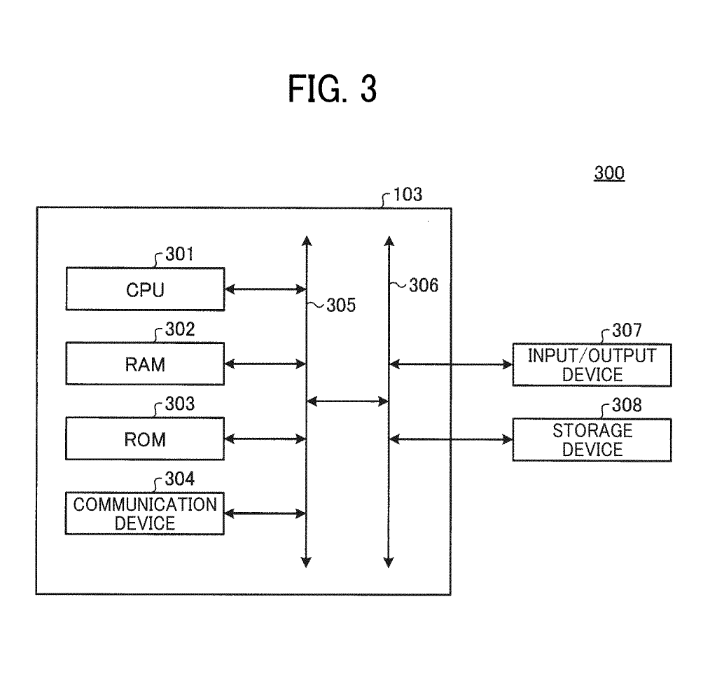

FIG. 3 illustrates a hardware block 300 of the PC 103 being an exemplary information terminal. The PC 103 includes a CPU 301, a RAM 302, a ROM 303, and a communication device 304, connected through a system bus 305. The system bus 305 is connected to an I/O bus 306 through a bus bridge such as PCI or PCI Express.

The I/O bus 306 is connected to an input/output device 307 such as a mouse or a keyboard, and a storage device 308 such as a HDD, in compliance with an appropriate protocol. Note that, the input/output device 307 may include an operation panel including a touch sensor in a case where the information processing device includes the smartphone 105 or the tablet PC 104. The storage device 308 stores software such as an OS, a driver, and various applications. The CPU 301 reads the program from the storage device 308 to the RAM 302, to implement various functions onto the PC 103, the tablet PC 104, or the smartphone 105 to perform operation.

Examples of the CPU 301 in the PC 103 include, depending on the type of the information processing device, a PENTIUM (registered trademark) compatible CPU, POWER PC (registered trademark), and million instructions per second (MIPS), and Tegra (registered trademark), Exynos (registered trademark), and Snapdragon (registered trademark) used exclusively by a portable terminal, in addition to PENTIUM (registered trademark) to PENTIUM IV (registered trademark), ATOM (registered trademark), CORE 2 DUO (registered trademark), CORE 2 QUAD (registered trademark), and COREi (registered trademark) in series.

Examples of the operating system (OS) to be used, include, but are not limited to, Mac OS (registered trademark), iOS (registered trademark), Windows (registered trademark), UNIX (registered trademark), LINUX (registered trademark), CHROME (registered trademark), ANDROID (registered trademark), and any other appropriate OS. Furthermore, the PC 103 may store and execute an application program described in a machine-dependent program language recently referred to as a so-called “App”, in addition to an assembler language, C, C++, Visual C++, Visual Basic, Java (registered trademark), JavaScript (registered trademark), Perl, and Ruby, to run on the OS described above.

The hardware configuration illustrated in FIG. 3 can be applied even in a case where the information terminal includes the tablet PC 104. Furthermore, the hardware configuration illustrated in FIG. 3 can be generally applied for the smartphone 105 except that a telephone communication function is provided.

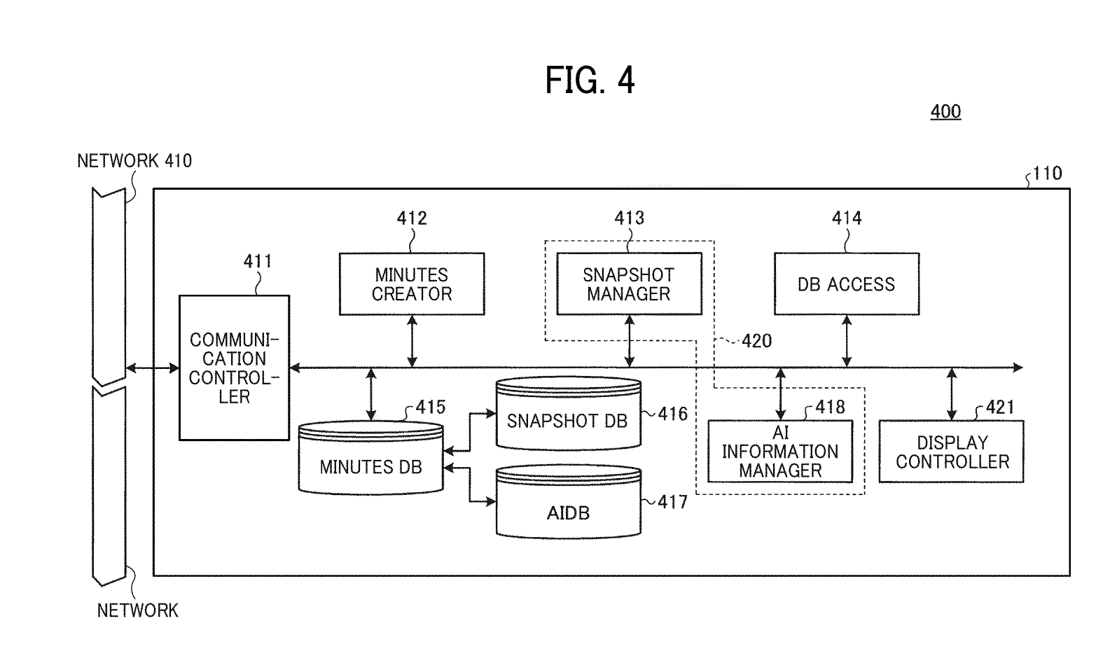

FIG. 4 illustrates a functional block 400 of the server 110 according to the first embodiment. Note that, each functional block illustrated in FIG. 4 corresponds to a function implemented onto the server 110 with the hardware of the server 110 functioning due to a server executable program. According to the present embodiment, the server 110 combines presentations made at a number of places, and allocates a unique identification value to each electronic meeting, to create and manage minutes data based on the combined presentations. The server 110 provides the minutes data so that a participant can refer to minutes. The minutes data corresponds to the meeting information according to the present embodiment. The server 110 includes a communication controller 411 that allows transmission and reception with respect to a network 410, a minutes creator 412, and a minutes database (hereinafter, simply referred to as a DB) 415.

The communication controller 411 uses the network interface card (NIC) to allow communication based on a protocol, such as Ethernet (registered trademark). The minutes creator 412 buffers individual pieces of data sent from a number of the places and combines the pieces of data to create minutes data of one electronic meeting. Then, the minutes DB 415 stores the minutes data to allow asynchronous reference during or after the end of meeting. The minutes creator 412 corresponds to an meeting information generating unit according to the present embodiment.

Furthermore, the server 110 includes partial information generator 420. The partial information generator 420 extracts part of the minutes data (the meeting information) to generate partial information having a data format compatible to an output device (“output data format”). The output data format is a data (a file) format capable of being output (displayed, projected, or printed) to the displays of the information terminal (the PC 103 or the tablet PC 104) and the output device (the whiteboard 106 or the image processing device 102). Examples of the output data format include image data formats, such as joint photographic experts group (JPEG), graphics interchange format (GIF), and bitmap. For example, in a case where the minutes data is made in a text format and the output device displays image data, the partial information generator 420 converts text data extracted from the minutes data into image data, such as JPEG, to generate the partial information. The partial information generator 420 provides a function of managing the partial information that has been generated, as a data file different from the minutes data. According to the present embodiment, the partial information generator 420 includes, more particularly, a snapshot manager 413 and an AI information manager 418. The snapshot manager 413 corresponds to a unit of managing creation, record, and provision of the snapshot corresponding to the partial information according to the present embodiment. The snapshot manager 413 allows partial reference of the meeting information after the electronic meeting finishes. The snapshot manager 413 captures data or a scene to be desirably reviewed later by a user, to generate the snapshot in real time from the electronic meeting data (the minutes data) in information displayed on the whiteboard 106 during the electronic meeting. Then, a snapshot DB 416 stores the snapshot. The snapshot DB 416 corresponds to a unit of storing the snapshot according to the present embodiment.

The AI information manager 418 corresponds to a unit of managing creation, record, and provision of the information for requesting the action to be taken, the information corresponding to the partial information according to the present embodiment. The AI information manager 418 allows asynchronous partial reference of the meeting information as AI information after the electronic meeting finishes. Based on a result of the electronic meeting, the AI information manager 418 extracts the information for requesting the action to be taken (hereinafter, simply referred to as an action item (AI)) in response to the request from the user. Then, an AI DB 417 stores the information in a manner that is referable.

The minutes DB 415, the snapshot DB 416, and the AI DB 417 will each be described as an independent DB in FIG. 4, but the snapshot DB 416 and the AI DB 417 can be integrally made as a DB. The implementation format can appropriately vary in dependence on a specific embodiment. The AI DB 417 corresponds to a unit of storing the information for requesting the action to be taken based on the result of the electronic meeting according to the present embodiment.

Furthermore, the server 110 includes a DB access 414 and a display controller 421. The DB access 414 controls writing and reading with respect to the minutes DB 415, the snapshot DB 416, and the AI DB 417 so that the respective DBs 415 to 417 can manage the minutes data, the snapshot, and the AI information. The display controller 421 controls provision of live data of the electronic meeting, as video, to the information terminal, the electronic whiteboard, or the screen on the user side. The display controller 421 can be implemented as a server application that uses a structured document, such as hypertext markup language (HTML) or extensible markup language (XML), a moving image file, an image file, and an audio file, with browser software, JAVA (registered trademark), JavaScript (registered trademark), or hypertext preprocessor (PHP). Note that, the display controller 421 corresponds to an output control unit according to the present embodiment.

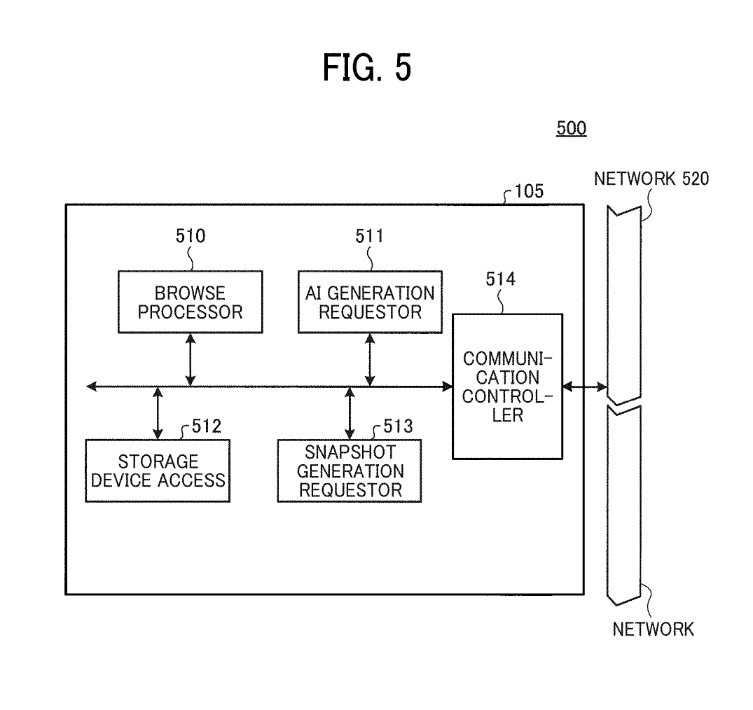

FIG. 5 illustrates a functional block diagram 500 of the information terminal, such as the PC 103, the tablet PC 104, or the smartphone 105, according to the first embodiment. Note that, the information terminal will be exemplarily described as the smartphone 105 in FIG. 5. The smartphone 105 includes a browse processor 510, a storage device access 512, and a snapshot generation requestor 513. The browse processor 510 can include browser software, such as Internet Explorer (registered trademark), Mozilla (registered trademark), FireFox (registered trademark), or CHROME (registered trademark), and appropriately displays the browser software on a touch panel with JavaScript (registered trademark).

The storage device access 512 provides a function of storing a processing result and a download result of the smartphone 105 into a card-type storage device or a HDD, to allow a user of the smartphone 105 to refer to the minutes data, the snapshot, or the AI information.

The snapshot generation requestor 513 provides a function of selecting a content that the user desires to acquire for reference from the minute data being browsed and commanding the server 110 to create the snapshot. Furthermore, the smartphone 105 includes an AI generation requestor 511 and a communication controller 514. The AI generation requestor 511 selects information considered for the user to take an action of some kind, from the minutes data, and creates the AI information to the server 110 so that the management is requested. The communication controller 514 uses a communication infrastructure, such as wireless fidelity (WiFi), 3G, 4G, long term evolution (LTE), or IEEE802.x, to allow mutual communication with respect to the server 110 through a network 520.

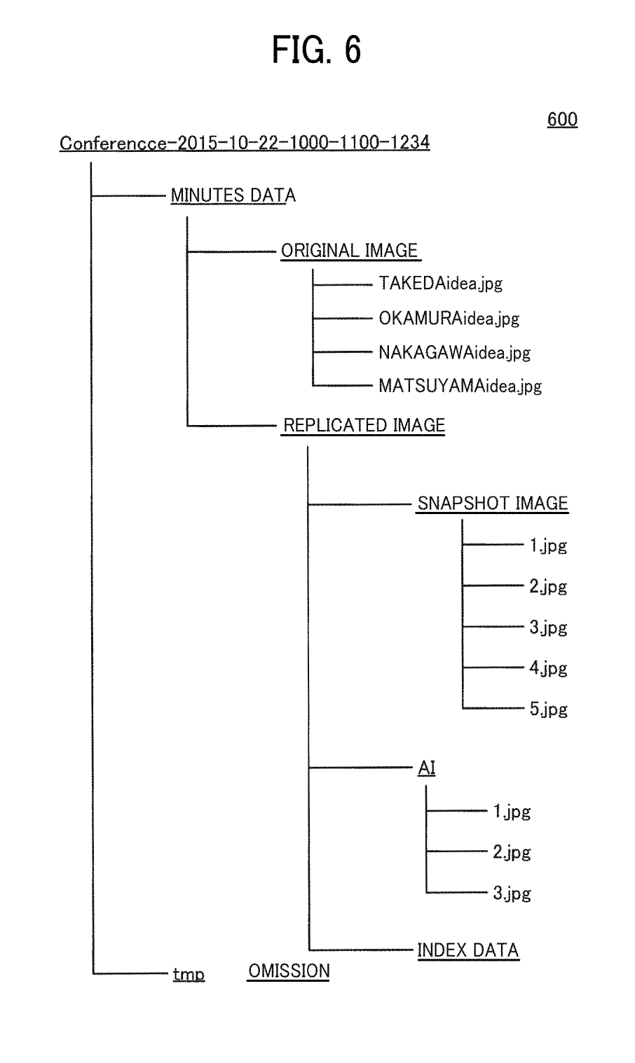

FIG. 6 is a diagram illustrating an exemplary data storage structure 600 of the minutes data, the snapshot data, and the AI information, managed in the server 110, according to the first embodiment. The minutes data is given with a unique identification value, for example, “Conference-2015-10-22-1000-1100-1234”, to be referable. The minutes data can include an original image (including a moving image and a still image), a snapshot image and an AI information image generated by extracting and replicating a part of the original image, and index data for effectively referring to a document and a replicated image.

FIG. 6 illustrates the original image, the snapshot image, and the AI information, each having a hierarchical structure. However, a configuration of storing each piece of information into an individual DB and making an inquiry and a reference independently, can be implemented.

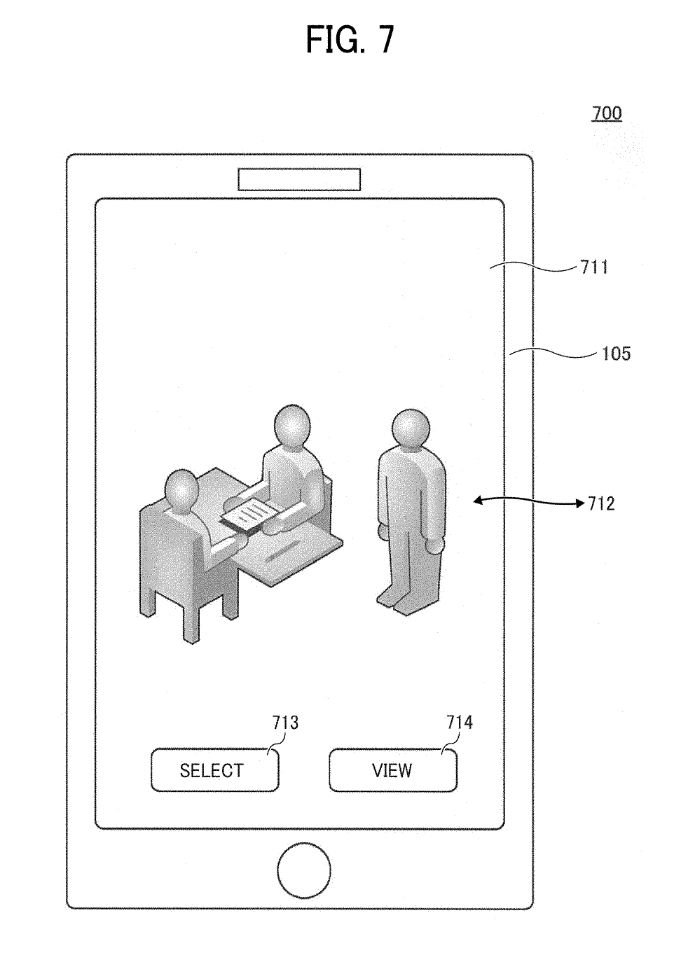

FIG. 7 illustrates an exemplary user interface 700 (hereinafter, simply referred to as an UI) displayed on a touch panel by the snapshot generation requestor 513 in the information terminal (the smartphone 105 as an illustrated example), according to the first embodiment. The touch panel 711 of the smartphone 105 displays an image of an electronic meeting 712, and the user can participate in the electronic meeting as a composite result of performances given at a plurality of places. The UI 700 displays buttons 713 and 714 that can be selected by the user in a case where processing relating to the snapshot is desired.

In a case where a scene, a document, or information considered to be desirably reviewed and confirmed later, appears on the touch panel 711 in accordance with the progress of the electronic meeting, the user touches the button 713 to capture the scene, the document, or the information. Note that, the capture can be instantaneously performed by the touch of the button 713. Alternatively, capturing, on a time-series basis, the contents of the electronic meeting until a touch is made again after the touch of the button 713, can make the snapshot.

Meanwhile, the touch panel 711 displays the other button 714 “View”. The button 714 allows the user to browse the snapshot acquired in the past. The button 714 is set to be active even in a case where no electronic meeting has been held. Thus, the user can refer to a specific snapshot of the electronic meeting authorized to the user. In a case where the snapshot is desirably reviewed in a state where no electronic meeting has been held, the button 713 can be set to be inactive.

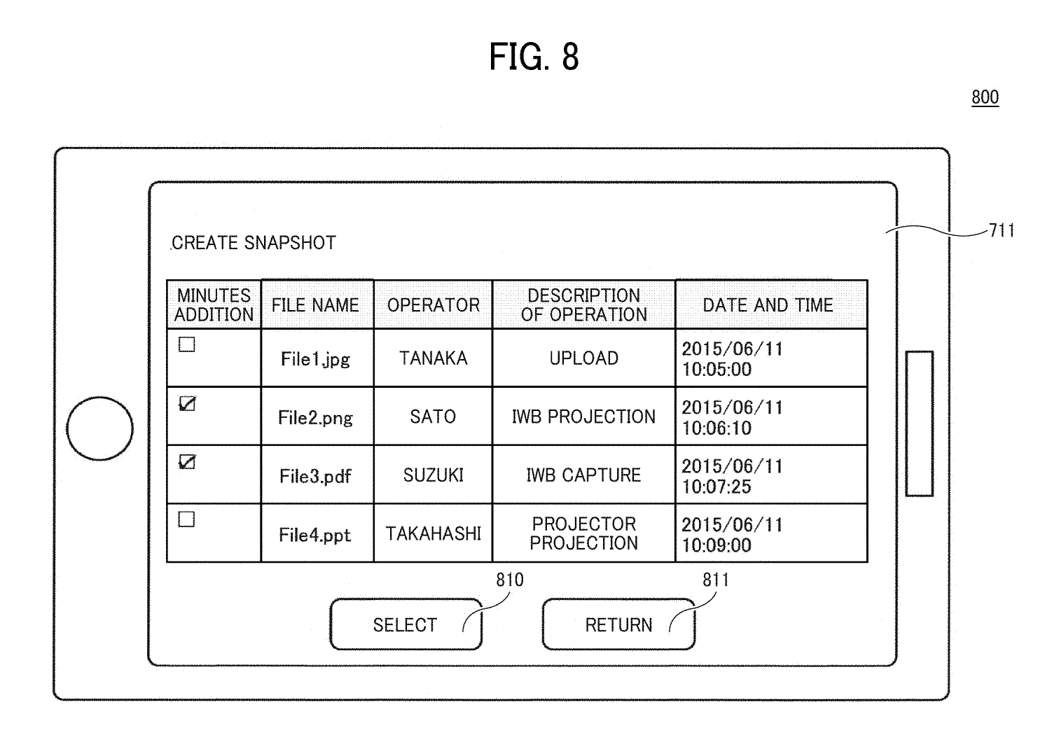

FIG. 8 illustrates an exemplary UI 800 displayed in a case where the user has touched the button 713 to select information for the snapshot on the UI 700 illustrated in FIG. 7. The UI 800 illustrates items for creating the snapshot, and lists pieces of image data included in the scene that has been selected, and the attribute information of the pieces of image data.

The UI 800 includes a check box for selecting a piece of image data, arranged. The user checks the lateral check box of a piece of image data to be desirably made to be the snapshot and then touches a button 810. After that, a snapshot generation command and object data information are sent to the server 110 so that the server 110 performs snapshot creation. Meanwhile, in a case where the user has no intention of creating the snapshot or in a case where the user desirably goes back to the electronic meeting screen, touching a button 811 can goes back to the electronic meeting screen.

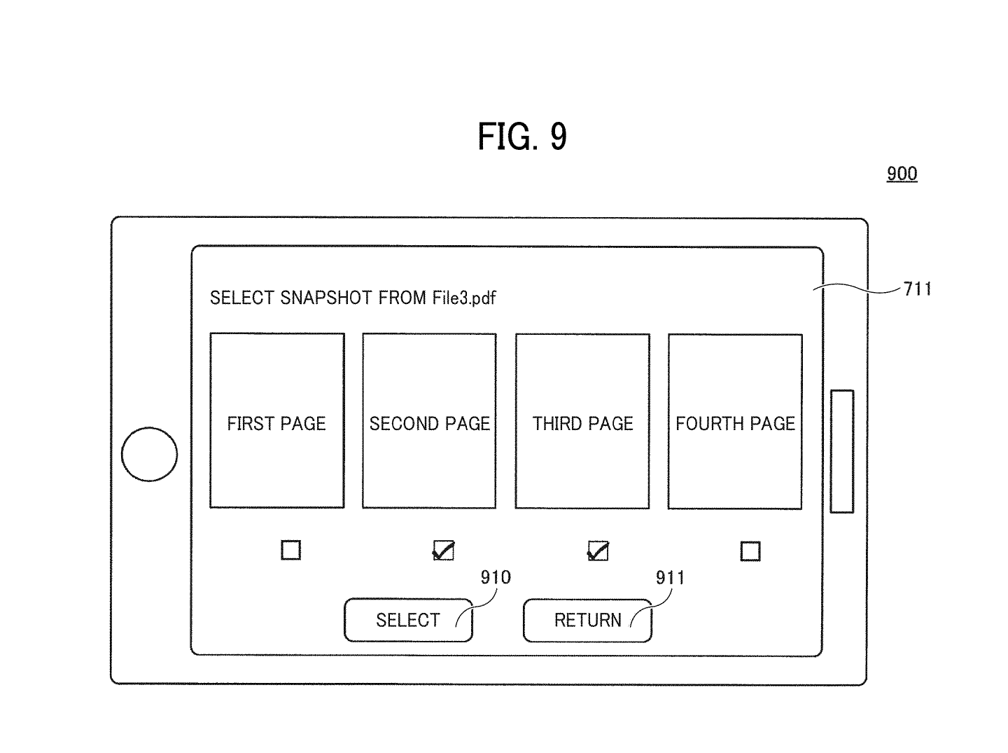

FIG. 9 illustrates an exemplary different UI 900 following the UI 800 illustrated in FIG. 8. The user has selected a file in a portable document format (PDF) format on the UI 800 illustrated in FIG. 8. In a case where the file in the PDF format includes a plurality of pages, snapshot creation can be performed per file in the PDF format. However, there is a disadvantage, such as the adaptability of a reader. Thus, the file is converted into a single file, such as JPEG, so that a browser can display the single file. The UI 900 illustrated in FIG. 9 exemplarily illustrates that the snapshot can be created per page in the PDF file in a case where the user has selected PDF.

When the user selects an interesting page in the PDF file through the check box and then touches a button 910, page information on the PDF file is sent together with other object data information so that the snapshot creation starts. In a case where the user desirably goes back to the previous page, when touching a button 911, the UI illustrated in FIG. 7 or 8 is returned back so that other processing can be further performed.

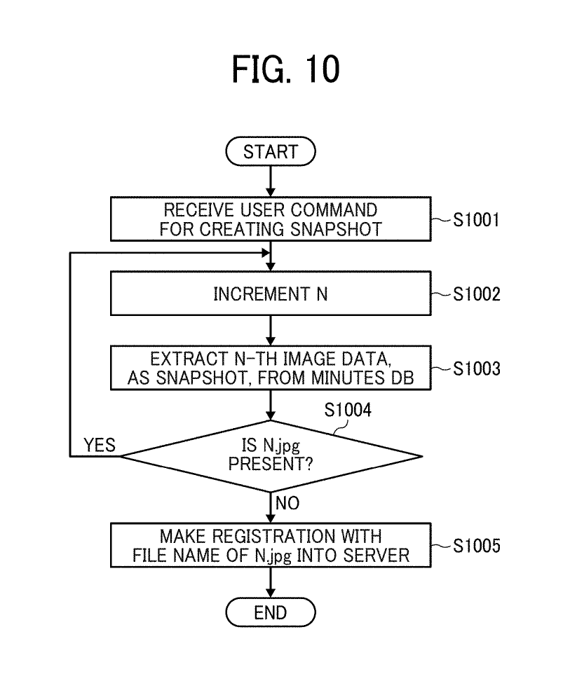

FIG. 10 is a flowchart of processing performed by the server 110 that has received the command for creating the snapshot from the information terminal, according to the first embodiment. At step S1001, the user command for creating the snapshot is received together with identification information on the image data to be created. At step S1002, N is incremented with an initial value satisfying the following expression: N=0. At step S1003, the N-th image data is cut out from the minutes data in the minutes DB 415 or an image buffer, to be converted into the snapshot.

At step S1004, it is determined whether the image data to be extracted is further present. In a case where the image data is present (Yes), the processing goes back to step S1002 so that the snapshot creation continues. Meanwhile, in a case where no image data is present (No) at step S1004, a file name of N.jpg is given as exemplary file name so that registration is made into the server 110, at step S1005. Then, the processing ends.

The processing is performed so that the snapshot of the minutes data can be created in substantially real time, with the stream of the electronic meeting not being interrupted.

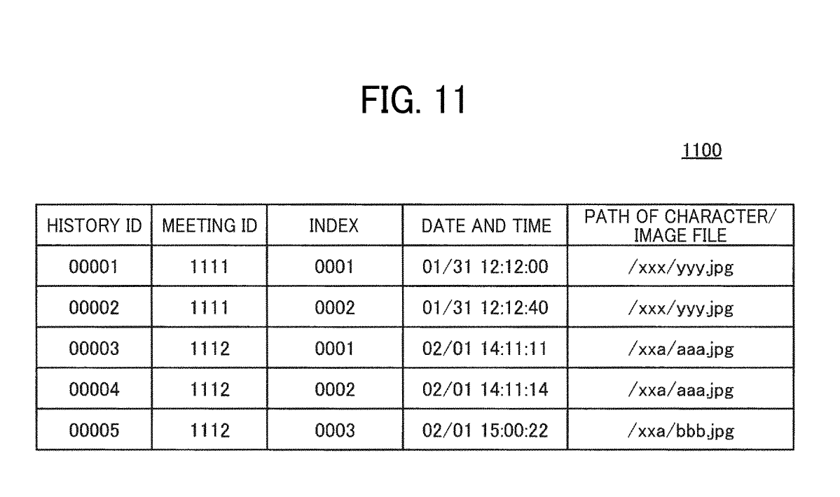

FIG. 11 illustrates exemplary index data 1100 for easily searching the snapshot and the AI information in a case where the snapshot and the AI information have been created, according to the first embodiment. The index data 1100 lists history ID identifying a created history, meeting ID for identifying a meeting, index indicating the order of an image file created in the corresponding meeting, time stamp indicating date and time, and the storage location.

The user searches a desired snapshot with information listed in the index data 1100 illustrated in FIG. 11 so that the snapshot can be displayed on the information terminal in response to the requirements. According to the present embodiment, the snapshot and the information for requesting the action to be taken can be projected by a projector or displayed onto an electronic whiteboard, in addition to the display screen of the information terminal. Note that, the embodiment of the index data 1100 illustrated in FIG. 11 is just exemplary, and thus different attribute information can be further added to the index data, according to the present embodiment. Instead of the path of the image file, the master key of a DB is registered so that direct reading can be performed from the DB.

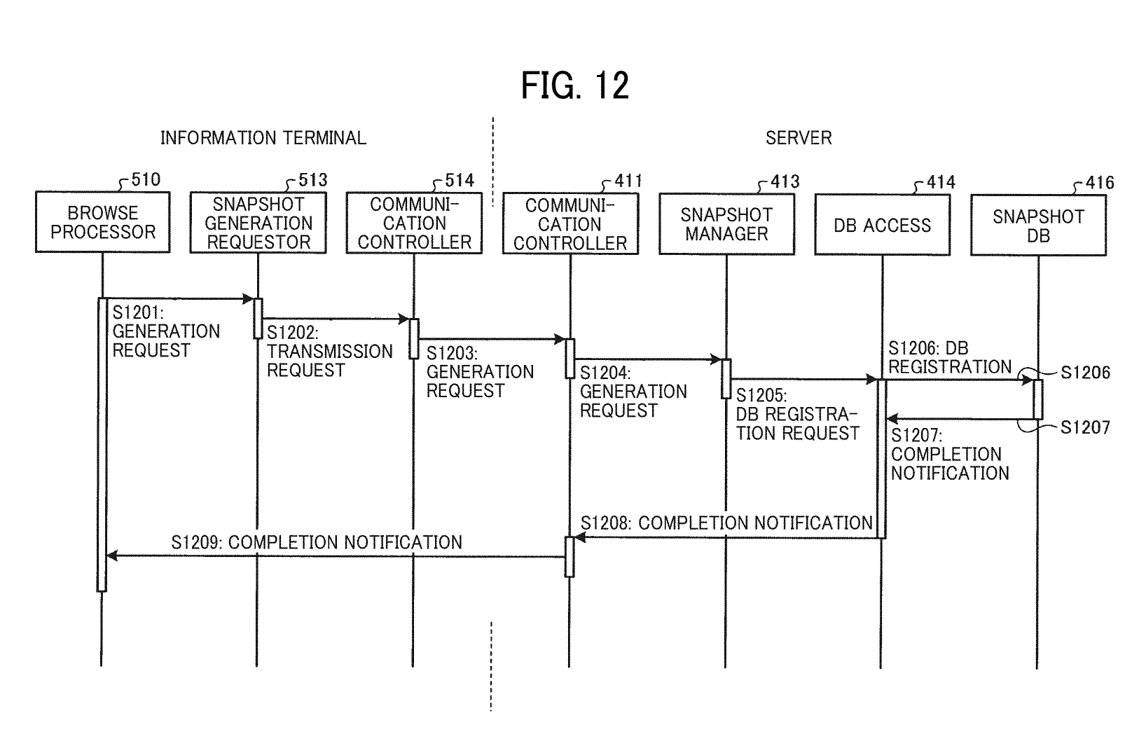

FIG. 12 is a sequence diagram illustrating the processing of creating the snapshot, according to the first embodiment. Note that, a broken line illustrated in the sequence diagram indicates a network boundary. In the sequence in FIG. 12, the user issues a generation request together with image data information, from the browse processor 510 to the snapshot generation requestor 513 on the information terminal (S1201). When receiving the request, the snapshot generation requestor 513 passes the generation request together with the image data information, to the communication controller 514 to request transmission (S1202). The communication controller 514 sends the generation request for the snapshot together with the image data information, to the server 110 (S1203).

When receiving the generation request, the communication controller 411 in the server 110 sends the generation request together with the image data information, to the snapshot manager 413 (S1204). The snapshot manager 413 extracts the corresponding image data present in the minutes DB 415 or the image buffer to create the snapshot. Then, the snapshot manager 413 issues a registration request for the snapshot, to the DB access 414 (S1205). When receiving the request, the DB access 414 registers the snapshot into the snapshot DB 416 (S1206). After the registration is completed, the snapshot DB 416 issues a completion notification to the DB access 414 (S1207) to send the completion notification to the browse processor 510 through the communication controllers 411 and 514 (S1208 and S1209).

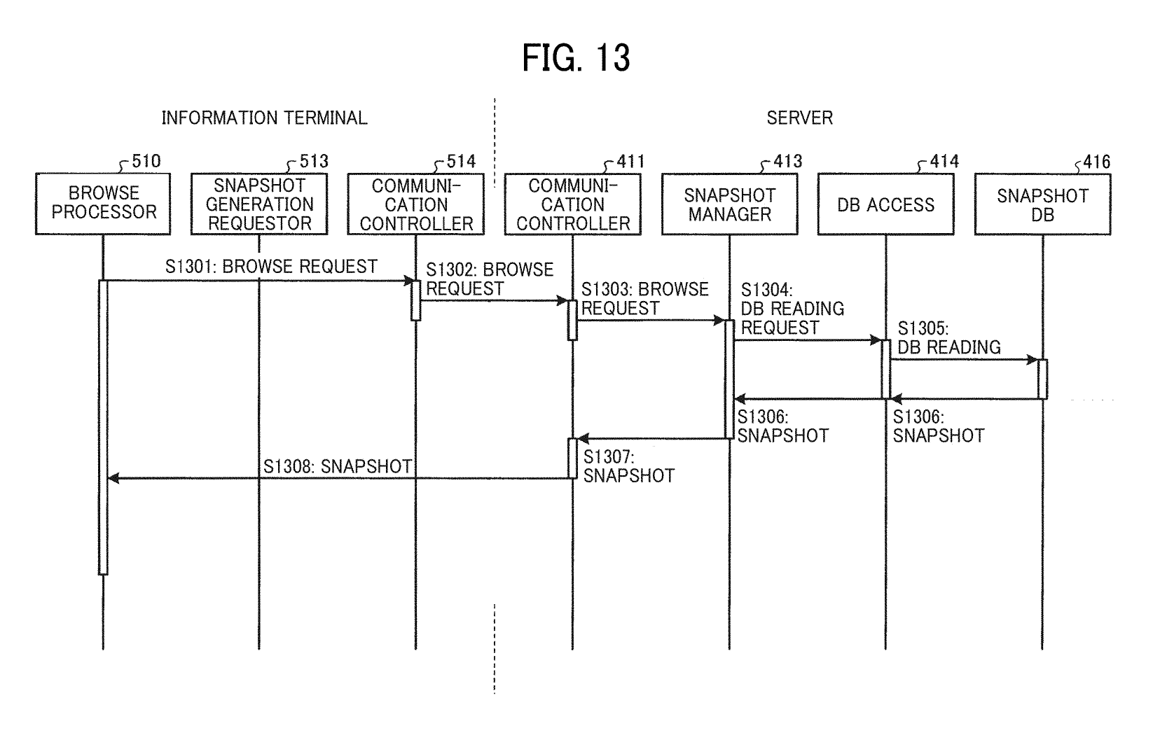

FIG. 13 is a sequence diagram in a case where the user browses the snapshot, according to the first embodiment. The user sends a browse request together with an identification value for specifying the snapshot, from the browse processor 510 in the information terminal to the communication controller 514 (S1301). The communication controller 514 sends the browse request that has been received, to the snapshot manager 413 through the communication controller 411 in the server 110 (S1302 and S1303).

When receiving the browse request, the snapshot manager 413 sends the identification value for specifying the snapshot together with a DB reading request, to the DB access 414 (S1304). The DB access 414 issues an inquiry with the identification value that has been received, to the snapshot DB 416 (S1305). The snapshot DB 416 extracts and passes the snapshot to the DB access 414 (S1306).

The DB access 414 sends the snapshot that has been received, to the browse processor 510 through the communication controller 411 and the communication controller 514 so that the user can browse the snapshot (S1307 and S1308).

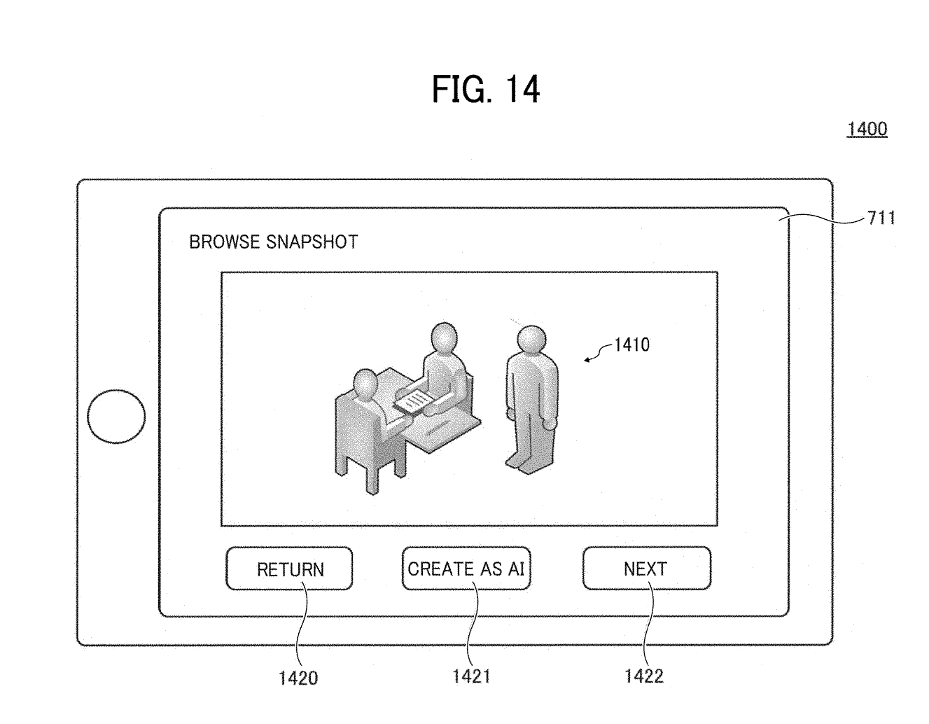

FIG. 14 is a diagram illustrating an exemplary UI 1400 from which the user browses the snapshot, according to the first embodiment. For the UI 1400 illustrated in FIG. 14, the information terminal is regarded as the tablet PC 104. The user reviews and considers the contents of an electronic meeting in the past, referring to a snapshot 1410 displayed on the touch panel 711. In this case, when discovering a matter about which a result is given until the next meeting, the user touches a button 1421 so that additional registration can be made as the AI information.

In addition, a mode in which touching a button 1420 and a button 1422 can browse the previous snapshot and the next snapshot, respectively, is provided in order for the user to browse the snapshot.

According to the first embodiment, a different example of creating the AI information will be described below. In the following example, the AI information indicates information relating to an object that requires an action of some kind to be taken and a report to be made until the date of the next electronic meeting.

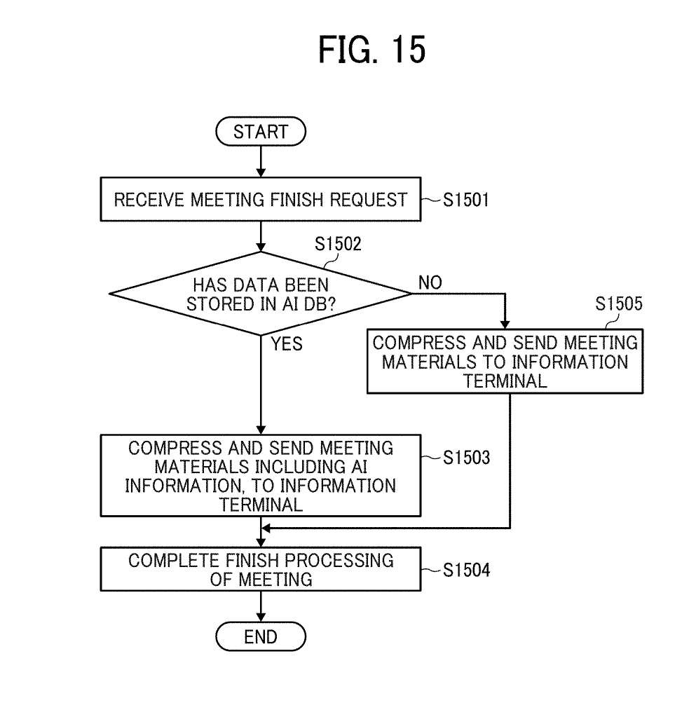

FIG. 15 is a flowchart of processing, performed by the server 110 in sending the AI information to the information terminal, according to the first embodiment. At step S1501, the server 110 receives a meeting finish request from an administrator user. At step S1502, it is determined whether data of the corresponding meeting has been stored in the AI DB 417. In a case where it is determined that the data is present in the AI DB 417 (Yes), at step S1502, meeting materials including the AI information are compressed and sent to the information terminal of a requestor at step S1503. At step S1504, finish processing of the meeting is completed.

Meanwhile, in a case where no AI information on the corresponding electronic meeting is present in the AI DB 417 (No) at step S1502, the meeting materials are compressed and sent to the information terminal of the requestor at step S1505. At step S1504, the finish processing of the meeting is completed.

Due to the processing, the administrator terminal being the sponsor of the meeting acquires the AI information in addition to the meeting materials so that matters relating to the AI information being the agenda are easily managed.

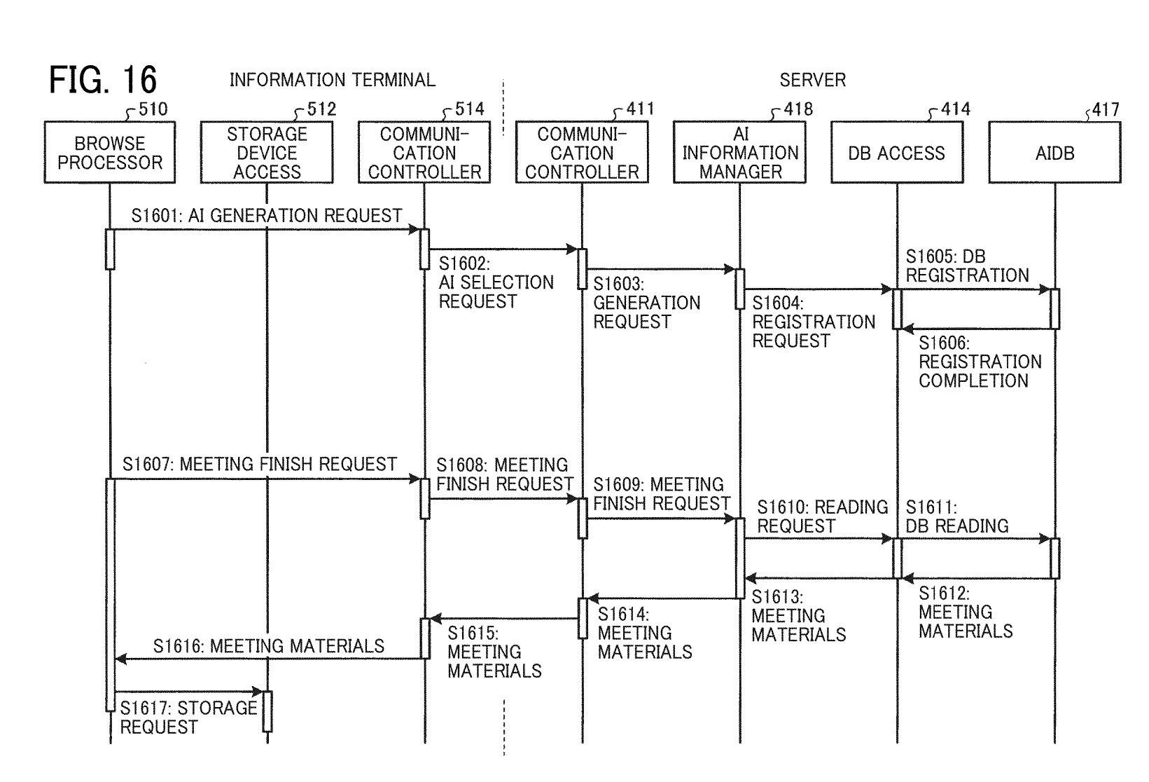

FIG. 16 is a sequence diagram illustrating processing of registering the AI information and storing the AI information into the information terminal in response to the finish of the electronic meeting, according to the first embodiment. In the processing in FIG. 16, when the browse processor 510 in the information terminal selects information to be registered as the AI information and issues an AI generation request (S1601), the AI generation request is sent to the AI information manager 418 through the communication controller 514 and the communication controller 411 (S1602 and S1603). In a case where the snapshot to be as the AI information is present, the AI information manager 418 extracts the corresponding snapshot from the AI generation request to issue a registration request to the DB access 414.

Meanwhile, in a case where no corresponding snapshot is present, the AI information manager 418 reads the AI information from the minutes DB 415 to issue a registration request as the AI information (S1604). In a case where the snapshot to be as the AI information is present, the DB access 414 copies the corresponding snapshot into the AI DB 417 to create the AI information.

When receiving the DB registration request, the DB access 414 commands the AI DB 417 to make a DB registration (S1605). When completing the registration processing, the AI DB 417 notifies the DB access 414 of the registration completion (S1606). After that, the AI information manager 418 notifies the browse processor 510 of the registration completion, but the description of the processing in this case will be omitted.

A sequence of S1607 to S1617 relates to the meeting finish processing. The sequence of the meeting finish starts when the administrator issues a meeting finish request from the information terminal at S1607 (S1607). The meeting finish request is sent to the AI information manager 418 through the communication controller 514 and the communication controller 411 (S1608 and S1609). When receiving the meeting finish request, the AI information manager 418 issues a reading request for the AI information and the meeting materials, to the DB access 414 (S1610). For example, the DB access 414 issues a structure query language (SQL) inquiry to extract the corresponding AI information or issues a reading command to read the AI information (S1611). The AI information is returned to the DB access 414 (S1612).

When receiving the AI information, the DB access 414 passes the AI information to the browse processor 510 through the AI information manager 418, the communication controller 411, and the communication controller 514 (S1613, S1614, S1615, and S1616). When receiving the AI information, the browse processor 510 issues a storage request for the AI information, to the storage device access 512 to store the AI information into a storage device (S1617). Note that, in a case where the AI information is present, the meeting materials are also compressed together with the AI information. After that, an appropriate function sends the meeting materials to the browse processor 510 so that the storage into the storage device is performed.

After the processing, the meeting materials may be deleted together with the AI information from the server 110, or may be transferred to a different DB, such as a log DB, for a purpose of management in the server 110.

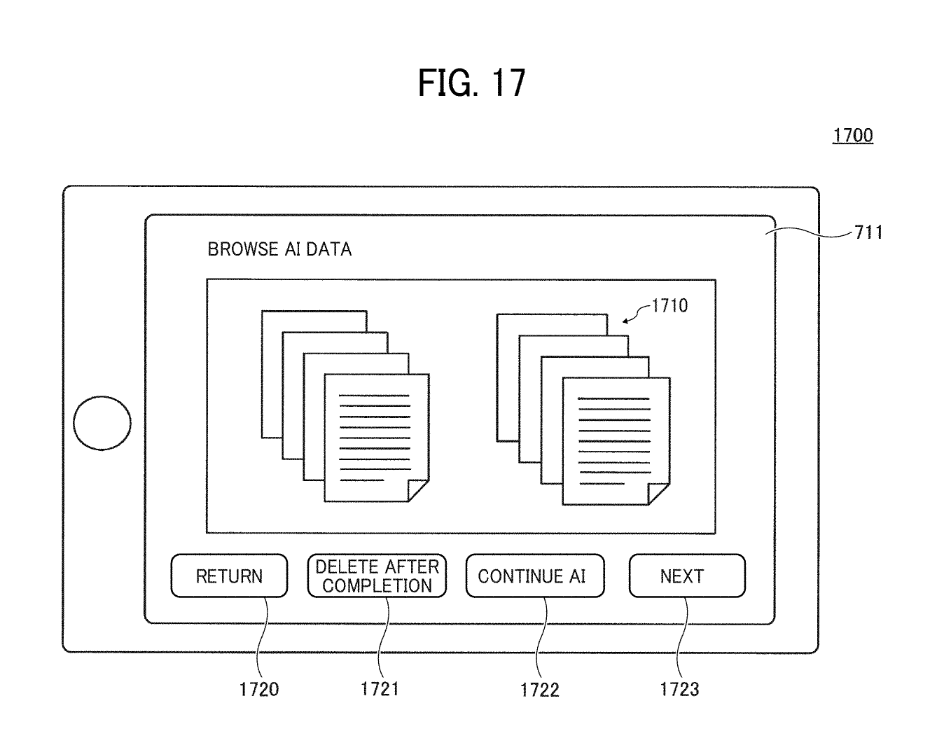

FIG. 17 is a diagram illustrating an exemplary UI 1700 in browsing AI data through the information terminal, according to the first embodiment. The UI 1700 displays browsing of the AI information, and AI information 1710 is displayed on the touch panel 711. The user touches buttons 1720 to 1723 referring to the UI 1700 so that desired processing can be performed.

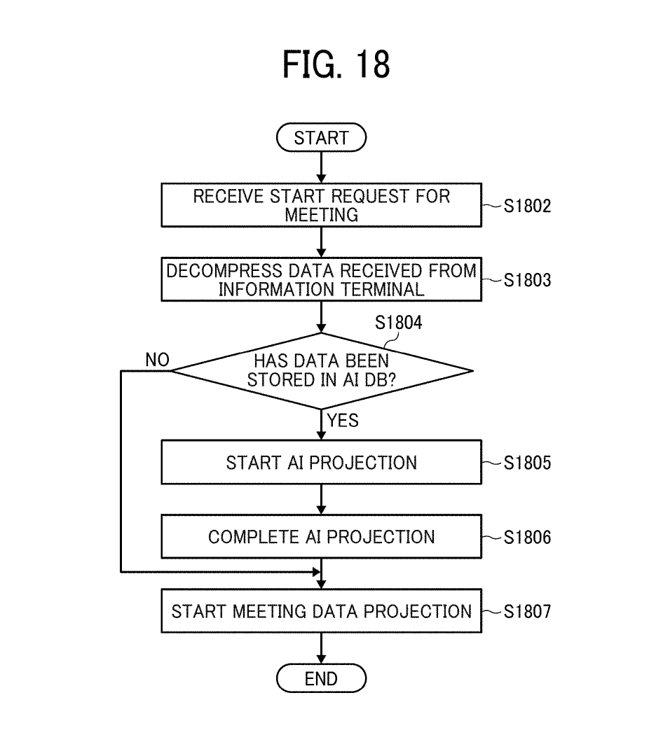

FIG. 18 illustrates processing performed by the server 110 in sharing the AI information obtained at a number of places during the electronic meeting, according to the first embodiment. At step S1802, a start request for the meeting is received from the information terminal of the administrator user. At step S1803, data that has been received from the information terminal is decompressed and then the minutes data and the AI information (if present) are each extracted to be registered into the corresponding DB. At step S1804, it is determined whether the AI DB 417 has acquired the data. In a case where the AI DB 417 has no data (No), the processing proceeds to step S1807 so that projection of the meeting data starts.

Meanwhile, in a case where the AI DB 417 has acquired the data (Yes) at step S1804, projection of the AI information starts at step S1805, and then the projection of the AI information is completed at step S1806. Between step S1805 and step S1806, the display of the AI information is managed by the control of the information terminal of the administrator. After the display of the AI information is no longer required, the projection of the meeting data starts at step S1807 and the processing is passed to different control. Then, the electronic meeting start processing finishes. Due to the processing, the subsequent meeting can progress based on the AI information that can be translated into the previous issue, prior to the start of the electronic meeting. Thus, the agenda can effectively progress without omission.

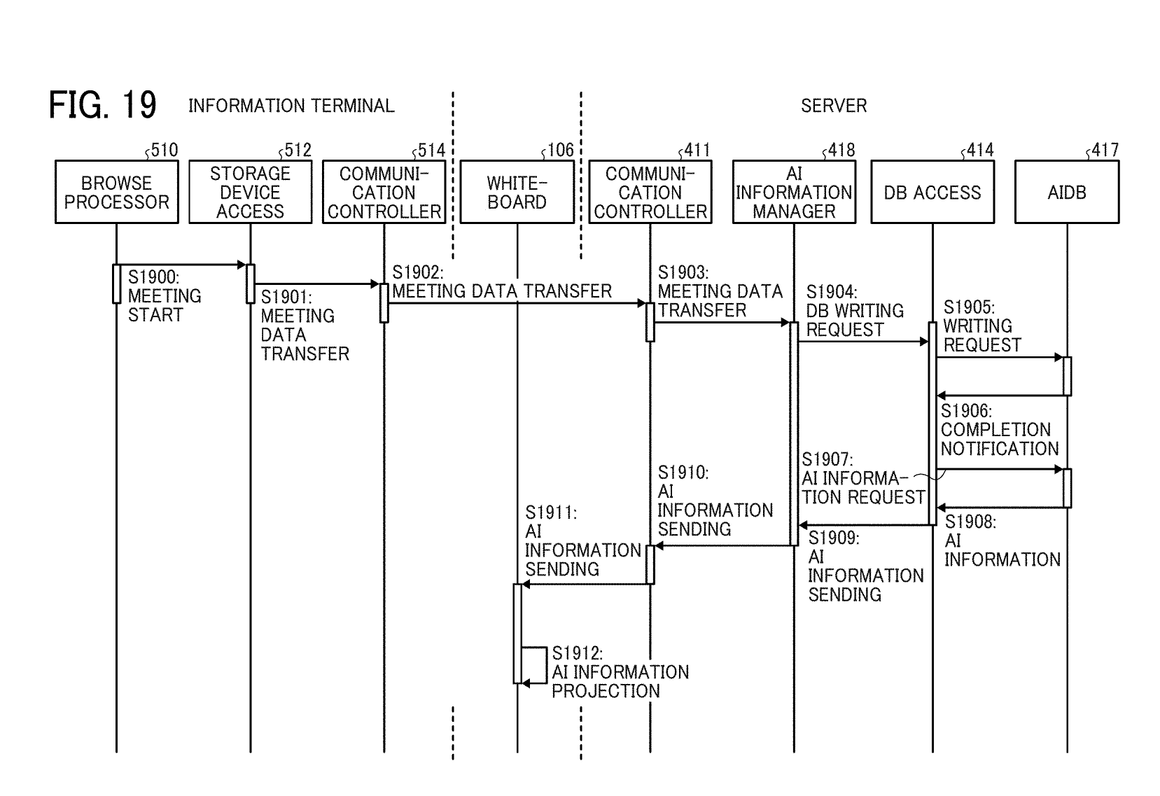

FIG. 19 is a sequence diagram in a case where the electronic meeting starts in the information processing system 100 according to the first embodiment. The user commands the storage device access 512 to make a meeting start, from the browse processor 510 in the information terminal (S1900). Then, the storage device access 512 reads the meeting data from the storage device and sends the meeting data to the AI information manager 418 in the server 110 through the communication controller 514 and the communication controller 411 (S1901, S1902, and S1903). The AI information manager 418 issues a writing request for the meeting data, to the DB access 414 (S1904).

The DB access 414 issues a writing request to the AI DB 417 since the meeting data includes the AI information, according to the present embodiment (S1905). The AI DB 417 issues a completion notification to the DB access 414 after the writing is completed (S1906). When receiving the notification, the DB access 414 requests the AI information associated with the corresponding electronic meeting, from the AI DB 417 (S1907). When receiving the request, the AI DB 417 reads the AI information and then sends the AI information to the DB access 414 (S1908).

The DB access 414 sends the AI information to the AI information manager 418 (S1909). The AI information manager 418 sends the AI information to the whiteboard 106 through the communication controller 411 (S1910 and S1911). The whiteboard 106 projects the AI information that has been received, onto the display screen with the projector (S1912) so that the AI information can be displayed prior to the start of the electronic meeting.

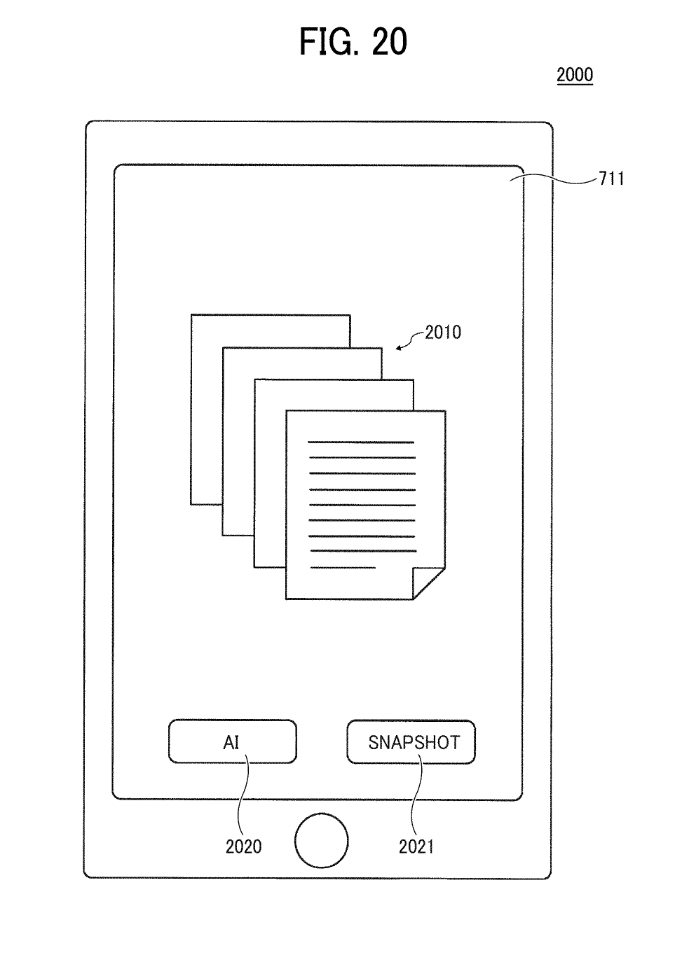

FIG. 20 illustrates an exemplary UI 2000 for creating the AI information or the snapshot during the progress of the electronic meeting, according to the first embodiment. Video is displayed on the screen of the touch panel 711 in accordance with the electronic meeting, and meeting materials 2010 are displayed in the video. The UI 2000 includes an “AI” button 2020 touched in a case where the user registers the materials being displayed as the AI information and a “Snapshot” button 2021 touched in a case where the user registers the materials as the snapshot, formed. The above UI 2000 is used so that the AI information can be directly generated from the meeting materials 2010 displayed on the screen. That is, the AI information can be generated without selection of the AI information from the snapshot.

According to the first embodiment, while meeting materials considered to be desirably made to be the AI information or meeting materials to be desirably made to be the snapshot for reviewing later, are being displaying from the meeting materials, the user can create the AI information or the snapshot without a cumbersome procedure, in accordance with the user preference. Note that, according to the present embodiment, the AI information and the snapshot can be deleted after the user who has created the AI information and the snapshot makes browsing. Alternatively, the AI information and the snapshot are moved into a history storage that saves past histories, to be deleted from the snapshot DB 416 and the AI information DB 417, respectively, so that the storage capacity of each of the DBs 416 and 417 can be effectively used.

### Second Embodiment

A second embodiment will be described below with reference to the drawings. Elements the same as or similar to the elements according to the first embodiment, are denoted with the same reference signs, and thus the descriptions of the elements may be omitted.

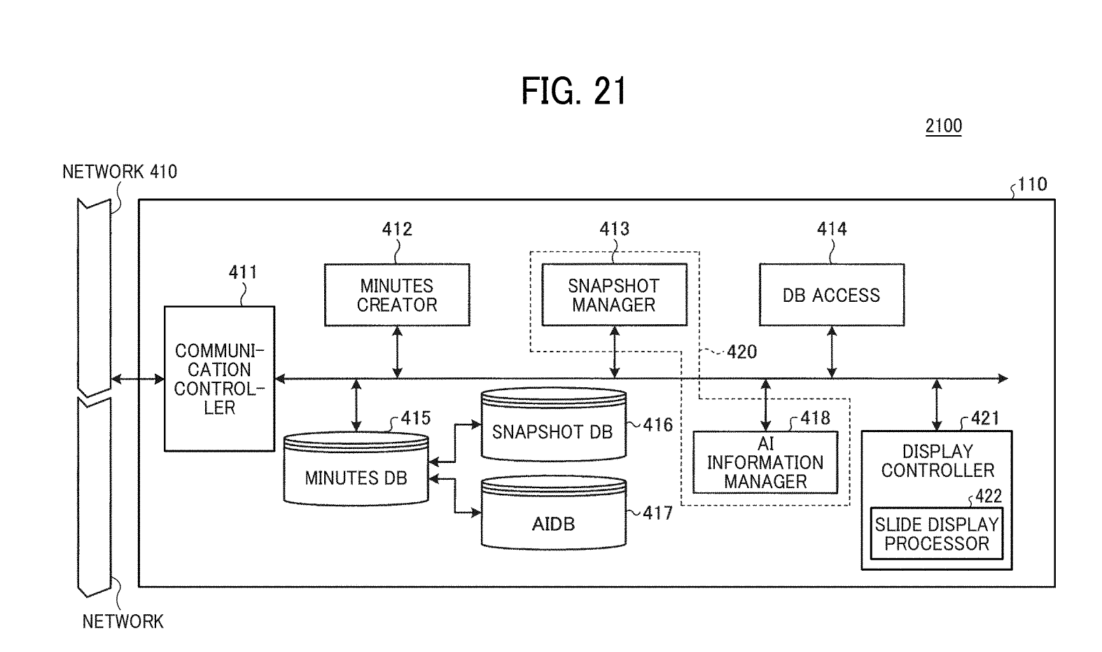

FIG. 21 illustrates a functional block 2100 of a server 110 according to the second embodiment. The display controller 421 in the server 110 according to the second embodiment further includes a slide display processor 422. The slide display processor 422 performs processing to perform a slide function of sequentially outputting at least one image of a snapshot stored in the snapshot DB 416 onto the display of an information terminal (e.g., a touch panel 711) or an output device (e.g., a whiteboard 106), automatically or manually.

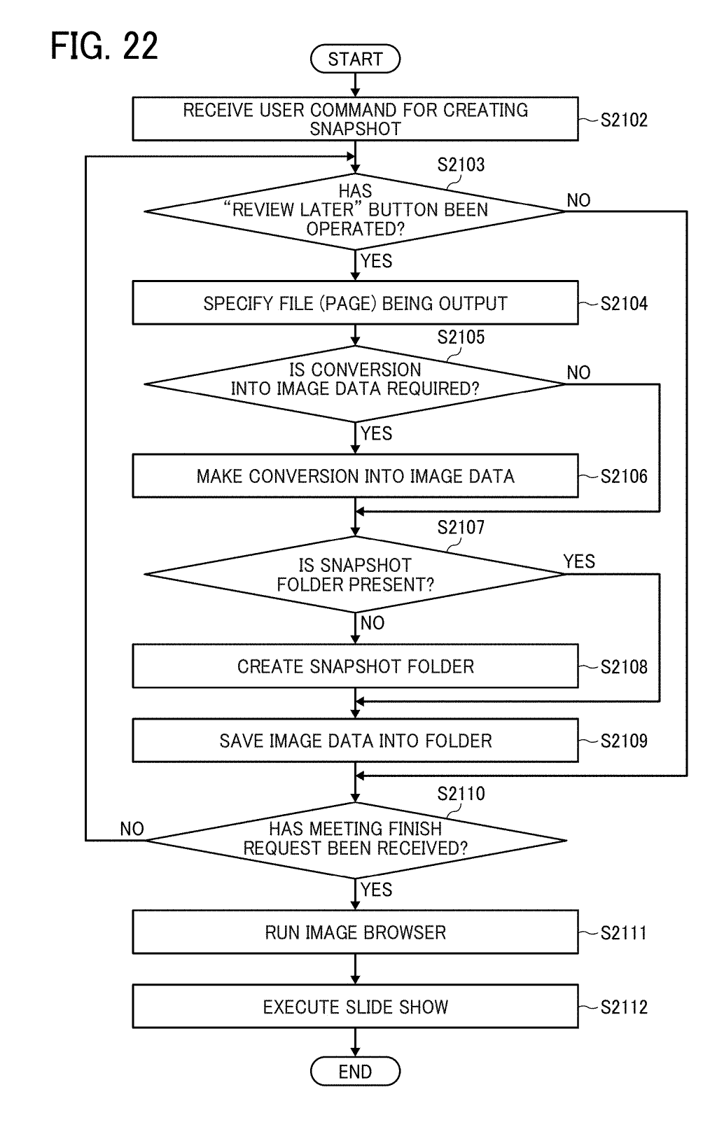

FIG. 22 is a flowchart of processing performed by the server 110 that has received a command for creating a snapshot from an information terminal, according to the second embodiment. At step S2102, the snapshot manager 413 receives the user command for creating the snapshot.

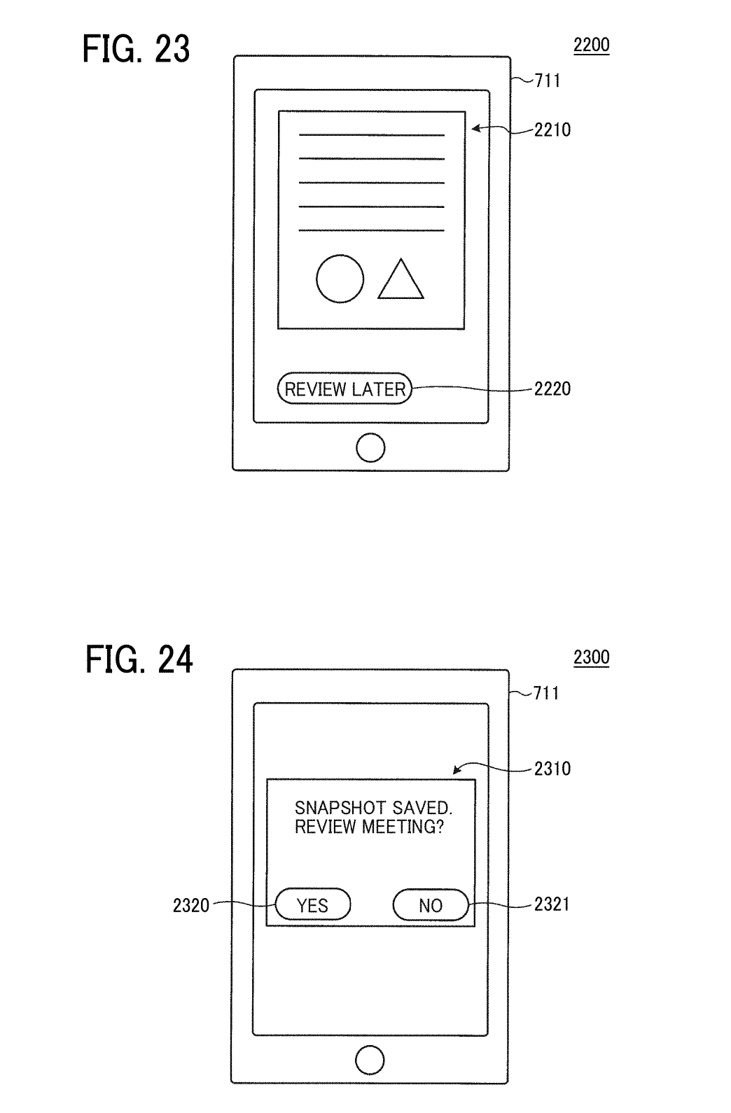

FIG. 23 illustrates an exemplary UI 2200 for creating the snapshot during the progress of an electronic meeting, according to the second embodiment. Here, the UI 2200 displayed onto the screen of the touch panel 711 of the information terminal (e.g., a tablet PC 104), is exemplified. The UI 2200 displays video in accordance with the progress of the electronic meeting and displays meeting materials 2210. The UI 2000 includes a “Review later” button 2220, which may be touched by a user in a case where the meeting materials 2210 being displayed are registered as the snapshot. The user command at step S2102 in FIG. 22 is issued through the UI 2200.

Referring back to the flowchart in FIG. 22, the snapshot manager 413 determines whether the “Review later” button 2220 has been operated, at step S2103. In a case where the “Review later” button 2220 has not been operated (No), it is determined whether a meeting finish request has been received, at step S2110 to be described. Meanwhile, in a case where the “Review later” button 2220 has been operated (Yes) at step S2103, the snapshot manager 413 specifies a file or a page being output onto the output device when the “Review later” button 2220 is operated (e.g., the meeting materials 2210 being displayed on the touch panel 711 illustrated in FIG. 23), at step S2104. The snapshot manager 413 or the minutes creator 412 performs appropriate processing of grasping minutes data currently being output so that the specification of the file (or the page) can be achieved.

After that, the snapshot manager 413 determines whether the file (or the page) that has been specified is required to be converted into image data, at step S2105. In a case where the conversion into the image data is required (Yes), the file that has been specified is converted into the image data at step S2106. Determining in what case the conversion into the image data is required, is a matter appropriately set in accordance with the specifications of the information terminal or the output device. For example, in a case where the file that has been specified includes text data or PDF data, it can be determined that the conversion into the image data, such as JPEG, is required. Meanwhile, in a case where no conversion into the image data is required (No) at step S2105, the processing at step S2106 is skipped. After that, the snapshot manager 413 determines whether a snapshot folder is present in a storage area for snapshot data, at step S2107. In a case where no folder is present (No), the folder is created at step S2108. The image data (snapshot data) is saved in the folder at step S2109. Meanwhile, in a case where the folder is present (Yes) at step S2107, the image data is saved in the folder that has already been created, at step S2109.

After that, the snapshot manager 413 determines whether the meeting finish request has been received from the information terminal, at step S2110. In a case where the reception has not been made (No), the processing goes back to step S2103 to be performed again. Meanwhile, in a case where the meeting finish request has been received (Yes) at step S2110, the slide display processor 422 in the display controller 421 runs an image browser at step S2111, and performs the slide show function of sequentially displaying the image data (the snapshot) saved in the folder, at step S2112.

FIG. 24 illustrates an exemplary UI 2300 for displaying the slide show of the snapshot when the electronic meeting finishes, according to the second embodiment. Here, the UI 2300 that has been displayed on the screen of the touch panel 711 of the information terminal (e.g., the tablet PC 104), is exemplified. The UI 2300 is displayed in a case where the information terminal has transmitted the meeting finish request and the snapshot has been stored in the snapshot DB 416. That is, when receiving the meeting finish request from the information terminal, the display controller 421 confirms whether the snapshot data has been stored in the snapshot DB 416. In a case where the storage has been made, the display controller 421 transmits data for displaying the UI 2300 on the touch panel 711, to the information terminal.

The UI 2300 includes a confirmation message 2310, a “Yes” button 2320, and a “No” button 2321. The confirmation message 2310 in the present example includes the effect that the snapshot created during the meeting is present and the effect of a question of whether review of the contents of the meeting is desired, described. In a case where the “Yes” button 2320 has been pressed, the slide display processor 422 performs processing of displaying an image of the snapshot onto the touch panel 711 or the whiteboard 106 as the slide show. In a case where the “No” button 2321 has been pressed, no slide show function is performed and thus processing of finishing the meeting is performed.

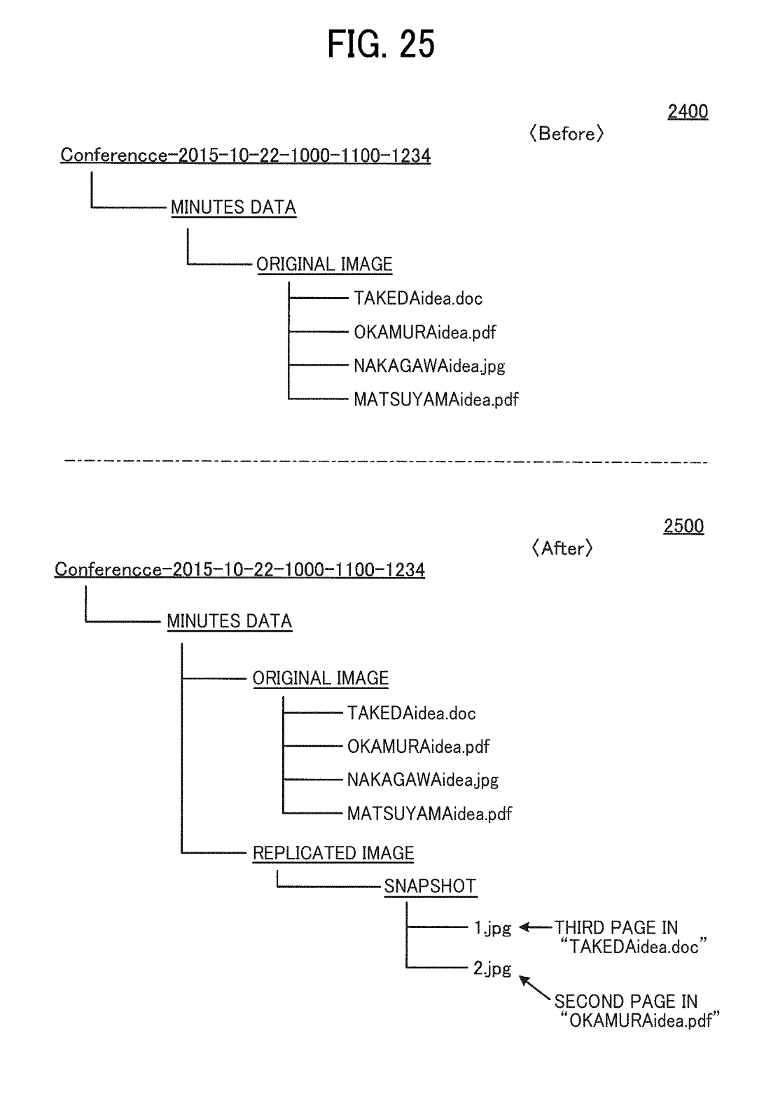

FIG. 25 is a diagram illustrating exemplary data storage structures 2400 and 2500 of the minutes data and the snapshot data, managed in the server 110, according to the second embodiment. FIG. 25 illustrates the data storage structure 2400 before a folder for saving the snapshot data is created and the data storage structure 2500 after the folder for saving the snapshot data is created. The folder corresponds to the folder at steps S2107 and S2108 in FIG. 22. The data storage structure 2500 includes the folder “Snapshot” created for saving snapshot data “1.jpg” and snapshot data “2.jpg” generated by extracting and replicating a part of an original image. The “1.jpg” is, for example, image data including the third page of a file “TAKEDAidea.doc” in the original image, converted into a JPEG format. The “2.jpg” is, for example, image data including the second page of a file “OKAMURAidea.pdf” in the original image, converted into the JPEG format. The pieces of snapshot data “1.jpg” and “2.jpg” generated in this manner are saved into the one folder “Snapshot”. The slide display processor 422 can perform the slide show function to, as objects, the pieces of snapshot data saved in the folder “Snapshot”. Note that, the method of saving the snapshot data is not limited to the above. The snapshot data is at least saved in a state where the slide show function can be performed.

According to the second embodiment, when the meeting finishes, the snapshot generated in the meeting can be output through the slide show. Accordingly, the user can collectively grasp the contents of the meeting.

Note that, according to the second embodiment, the snapshot has been an object for the slide show, but AI information may be an object for the slide show. In this case, the display controller 421 and the slide display processor 422 at least perform processing of confirming whether data of the AI information has been stored in an AI DB 417 and processing of displaying the AI information as the slide show.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing system comprising circuitry to:
generate meeting information indicating contents of a meeting, based on data used by the meeting, the data being stored in at least one information terminal connected through a network;
extract partial information from the meeting information to generate the partial information having an output format, based on a request received from the at least one information terminal through the network during the meeting; and
output the partial information to at least one of the at least one information terminal and an output device connected through the network, to cause the meeting information and the partial information to be transmitted to the at least one information terminal through the network.

2. The information processing system according to claim 1,
wherein the partial information includes a snapshot to be later used for reviewing the contents of the meeting and information for requesting an action to be taken as a result of the meeting, and
the circuitry controls at least one of creation, record, and provision of the snapshot and the information for requesting the action to be taken, concurrently with controlling the progress of the meeting.

3. The information processing system according to claim 2,
wherein the circuitry creates the snapshot to include, as a unit, a file or a page included in the file, in accordance with the request from the at least one information terminal.

4. The information processing system according to claim 2,
wherein the circuitry provides the information for requesting the action to be taken, created in the previously-held meeting, to a plurality of participants at a start of the meeting held right after the previously-held meeting.

5. The information processing system according to claim 1,
wherein the circuitry performs a slide show to sequentially output one or more pieces of the partial information.

6. The information processing system according to claim 5,
wherein the circuitry performs, when the meeting finishes, the slide show to output the partial information generated during the meeting to be completed.

7. An information processing device comprising circuitry to:
generate meeting information indicating contents of a meeting, based on data used by the meeting, the data being stored in at least one information terminal connected through a network;
extract partial information from the meeting information to generate the partial information having an output format, based on a request received from the at least one information terminal through the network during the meeting; and
output the partial information to at least one of the at least one information terminal and an output device connected through the network, to cause the meeting information and the partial information to be transmitted to the at least one information terminal through the network.

8. The information processing device of claim 7,
wherein the partial information includes a snapshot to be later used for reviewing the contents of the meeting and information for requesting an action to be taken as a result of the meeting, and
the circuitry controls at least one of creation, record, and provision of the snapshot and the information for requesting the action to be taken, concurrently with controlling the progress of the meeting.

9. The information processing device of claim 8,
wherein the circuitry creates the snapshot to include, as a unit, a file or a page included in the file, in accordance with the request from the at least one information terminal.

10. The information processing device of claim 8,
wherein the circuitry provides the information for requesting the action to be taken, created in the previously-held meeting, to a plurality of participants at a start of the meeting held right after the previously-held meeting.

11. The information processing device of claim 8,
wherein the circuitry performs a slide show to sequentially output one or more pieces of the partial information.

12. The information processing device of claim 11,
wherein the circuitry performs, when the meeting finishes, the slide show to output the partial information generated during the meeting to be completed.

13. An information processing method, comprising:
generating meeting information indicating contents of a meeting, based on data used by the meeting, the data being stored in at least one information terminal connected through a network;
extracting partial information from the meeting information to generate the partial information having an output format, based on a request received from the at least one information terminal through the network during the meeting; and
outputting the partial information to at least one of the at least one information terminal and an output device connected through the network, to cause the meeting information and the partial information to be transmitted to the at least one information terminal through the network.
